(19) United States
(12) Patent Application Publication
(10) Pub. No.: US 2024/0319017 A1
(43) Pub. Date: Sep. 26, 2024

(54) METHOD FOR CONTROLLING A MEASURING DEVICE, MEASURING DEVICE AND SYSTEM

(71) Applicant: NETZSCH-Gerätebau GmbH, Selb (DE)

(72) Inventors: Martin BRUNNER, Konradsreuth (DE); Thomas DENNER, Selb (DE); Thilo HILPERT, Selb (DE); Fabian WOHLFAHRT, Rehau (DE); Michael SCHÖNEICH, Selb (DE); Michael MÜLLER, Trabitz (DE); Thorsten HACHMANN, Thierstein (DE)

(21) Appl. No.: 18/609,265

(22) Filed: Mar. 19, 2024

Related U.S. Application Data
(60) Provisional application No. 63/453,481, filed on Mar. 21, 2023.

(30) Foreign Application Priority Data
Mar. 21, 2023 (DE) 102023107027.4

(51) Int. Cl. G01K 1/12; G01K 1/024

(52) U.S. Cl. CPC G01K 1/12; G01K 1/024

(57) ABSTRACT

A method for controlling a measuring device includes monitoring external influences on the measuring device by a sensor device and evaluating the monitored external influences by a controller of the measuring device. A measuring device and a system are disclosed including at least one measuring device.

### TECHNICAL FIELD

The disclosure herein relates to a method for controlling a measuring device, a measuring device, and a system.

### BACKGROUND

The determination of properties of different materials is of major importance for many applications in research and industry. For this purpose a variety of measuring devices are used which, depending on the application, sometimes provide very complex measuring processes.

The measuring devices used are sometimes sensitive to the external environment, especially, for example, temperature or vibrations. Such influences can affect the measured values determined by the measuring devices without being recognized by users and thus impair the accuracy of the measurements taken.

### SUMMARY

Against this background, it is the object of the disclosure herein to minimize the effects of undesirable external influences on measurement results.

This task is solved by a method, by a measuring device, and by a system having features disclosed herein.

Accordingly, a method for controlling a measuring device is provided. The method comprises monitoring external influences on the measuring device by a sensor device, and evaluating the monitored external influences by the controller of the measuring device.

Furthermore, a measuring device and a system are provided which are configured to perform the method according to the disclosure herein.

It is an underlying idea of the disclosure herein to constantly autonomously monitor and evaluate the external influences acting on the measuring device. As a result, a user of the measuring device is advantageously supported and relieved, which means that the effect of external influences on the measuring device or the measurements taken by the measuring device can be better taken into account or minimized.

According to an example embodiment of the method, the sensor device is integrated in the measuring device. As a result, influences acting directly on the measuring device can be monitored advantageously well.

According to an example embodiment of the method, the sensor device is arranged externally from the measuring device. This configuration can be particularly advantageous in laboratory environments with several measuring devices.

According to an example embodiment of the method, the monitored external influences comprise an ambient temperature, an ambient humidity, a solar radiation and/or vibrations of the measuring device. These influences can have a particularly large effect on the measuring device and are therefore taken into account to particular advantage.

According to an example embodiment of the method, a warning is outputted if the monitored external influences evaluated are outside a predetermined tolerance range. As a result, the correctness of the measurements performed by the measuring device can be ensured in a particularly advantageous way.

According to an example embodiment of the method, the evaluated, monitored external influences are taken into account in a measured value determined by the measuring device. As a result, measured values determined by the measuring device are advantageously determined precisely.

According to an example embodiment of the method, determining the measured value is carried out autonomously by the controller. As a result, a user of the measuring device can be advantageously relieved.

According to an example embodiment of the method, a notification is output if the monitored external influences evaluated indicate that maintenance or replacement of individual components of the measuring device is required in the near future. As a result, further indirect effects of external influences can be taken into account.

### BRIEF DESCRIPTION OF THE DRAWINGS

The disclosure herein is explained below with reference to the figures of the drawings. In the figures:

FIG. 1 is a schematic flow diagram for a method according to an example embodiment of the disclosure herein;

FIG. 2 is a schematic representation of a measuring device according to an example embodiment of the disclosure herein; and

FIG. 3 is a schematic representation of a system with a plurality of measuring devices according to an example embodiment of the disclosure herein.

In the figures, the same reference signs designate identical or functionally identical components, unless indicated to the contrary.

### DETAILED DESCRIPTION

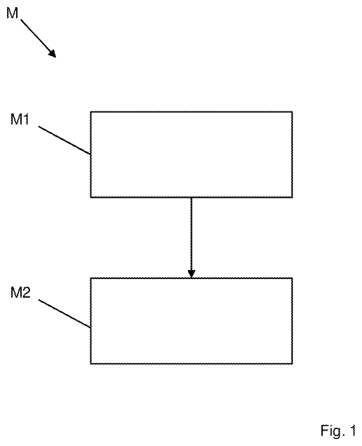

FIG. 1 shows a schematic flow diagram for a method M for controlling a measuring device according to an example embodiment of the disclosure herein.

In a first method step M1, a sensor device monitors external influences on the measuring device. In a further method step M2, a controller of the measuring device evaluates the monitored external influences.

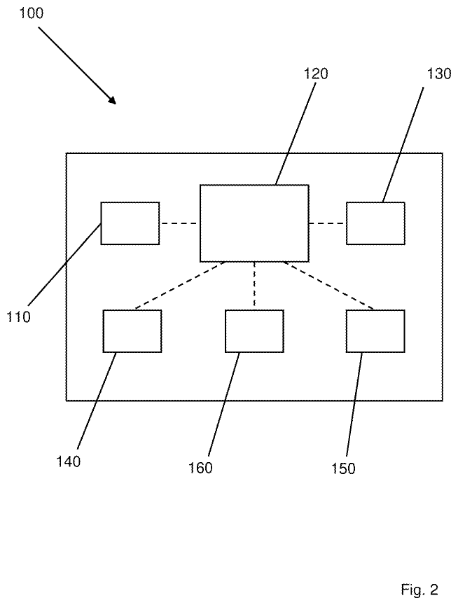

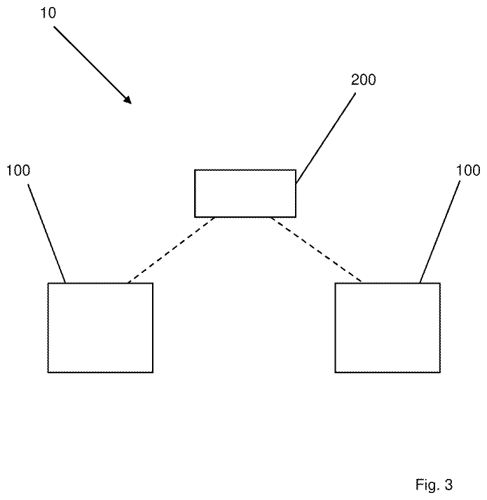

The method M shown is described in detail below with reference to FIGS. 2 and 3.

FIG. 2 shows a schematic representation of a measuring device 100 according to an example embodiment of the disclosure herein.

The measuring device 100 comprises a sensor device 110, a controller 120, a database 130, an outputting device 140, an inputting device 150, and a sample receiving device 160.

In the example embodiment shown here, the sensor device 110 is integrated in the measuring device 100 and is configured to monitor external influences on the measuring device 100. These external influences can include, for example, an ambient temperature, ambient humidity, solar radiation and/or vibrations of the measuring device.

The controller 120 is configured to evaluate the external influences monitored by the sensor device 110. For this purpose, the controller 120 can access the database 130, which in the present example embodiment is configured in the form of an internal memory of the measuring device 100. The database 130 can comprise a plurality of information about material properties and measurement methods, so that the controller 120 is able to evaluate the extent to which the monitored external influences affect the measured values determined by the measuring device 100.

The controller 120 can also be configured to output a warning if the evaluated, monitored external influences are outside a predetermined tolerance range. For example, the outputting device 140 of the measuring device 100 can be used for this purpose. The outputting device 140 may comprise, for example, a screen and/or speakers for this purpose. Alternatively or additionally, individually components of the measuring device 100, such as the inputting device 150 and the sample receiving device 160, can also be highlighted, for example by illuminating switch fields to be actuated or the like. The inputting device 150 may comprise, for example, a keyboard, a touch screen or the like. For example, the outputting device 140 and the inputting device 150 may be combined in a touchscreen.

It may also be provided that the evaluated, monitored external influences are taken into account in a measured value determined by the measuring device 100. For this purpose, the controller 120 in particular can be configured to autonomously determine the corresponding measured value.

Using the external influences evaluated by the controller 120 and monitored by the sensor device 110, it is also possible, in particular by the controller 120, to estimate whether maintenance or replacement might be required for the measuring device 100 or individually its components in the foreseeable future. In this case, there can be output a corresponding notification, for example by the outputting device 140.

In particular, the controller 120 may also be configured to update the database 130. As a result, for example, findings obtained when using the measuring device can be recorded in the database 130 and are then available for future measurements. The information required for this regarding the measurement performed can either be transmitted to the controller 120 by a user of the measuring device 100. Alternatively or additionally, the controller 120 can also receive the relevant information directly from the measuring device 100, in particular from the sensor device 110.

The measuring device 100 can be configured in particular as a device for the thermal analysis of materials. In particular, the measuring device 100 may be configured to perform differential thermal analyses, dynamic differential calometry, dynamic mechanical analyses, thermomechanical analyses or the like. During such measuring processes, the support of a user by the controller 110 can be particularly advantageous.

FIG. 3 shows a schematic representation of a system 10 with a plurality of measuring devices 100 according to an example embodiment of the disclosure herein.

In the example embodiment shown, the system 10 comprises a total of two measuring devices 100 and a sensor device 200.

The individually components of the system 10 can in principle be configured in exactly the same way as the corresponding components described with reference to FIG. 2. In the example embodiment shown here, only the sensor device 200 is configured externally from the two measuring devices 100 as an independent device.

Since the sensor device 200 is configured as a stand-alone device, it may be configured for use with either of the measuring devices 100. This means that external influences that affect both measuring devices 100, such as an ambient temperature, can be monitored efficiently and uniformly by just one sensor device 200. It is also conceivable to use an external sensor device 200 with sensor devices 110 integrated in the measuring devices 100, as shown for example in FIG. 2, wherein in this case the external and integrated sensor devices 200 and 110 each advantageously monitor external influences for which they are particularly suitable.

FIG. 3 shows two measuring devices 100. However, any number of measuring devices 100 can be provided. In particular, it may also be intended to use an individually measuring device 100 with an external sensor device 200.

The measuring devices 100 can be configured to have the same function or be configured to perform different measurements in each case. Depending on the application, this allows the respective measurement processes to be performed simultaneously or sequentially.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority

### LIST OF REFERENCE SIGNS

100 measuring device
110 sensor device
120 controller
130 database
140 outputting device
150 inputting device
160 sample receiving device
200 sensor device
M method
M1 method step
M2 method step

1. A method for controlling a measuring device, comprising:
monitoring external influences on the measuring device by a sensor device; and
evaluating the monitored external influences by a controller of the measuring device.

2. The method according to claim 1, wherein the sensor device is integrated in the measuring device.

3. The method according to claim 1, wherein the sensor device is arranged externally from the measuring device.

4. The method according to claim 1, wherein the monitored external influences comprise an ambient temperature, an ambient humidity, a solar radiation and or vibrations of the measuring device.

5. The method according to claim 1, further comprising outputting a warning if the evaluated, monitored external influences are outside a predetermined tolerance range.

6. The method according to claim 1, wherein the evaluated, monitored external influences are taken into account in a measured value determined by the measuring device.

7. The method according to claim 6, wherein determining of the measured value is carried out autonomously by the controller.

8. The method according to claim 1, further comprising outputting a notification if the evaluated, monitored external influences indicate that maintenance or replacement of individually components of the measuring device is necessary.

9. A measuring device configured to perform the method according to claim 1.

10. A system comprising at least one measuring device and a sensor device, wherein the system is configured to perform the method according to claim 1.
